(19) United States
(12) Patent Application Publication
(10) Pub. No.: US 2004/0150691 A1
(43) Pub. Date: Aug. 5, 2004

(54) Inkjet servicing apparatus and method

(76) Inventors: Carles Flotats, Barcelona (ES); Antonio Monclus, Barcelona (ES); Gonzalo Gaston, Barcelona (ES); Isabel Borrell, Barcelona (ES)

Correspondence Address: HEWLETT-PACKARD COMPANY, Intellectual Property Administration, P.O. Box 272400, Fort Collins, CO, 80527-2400, US

(21) Appl. No.: 10/356,367

(22) Filed: Jan. 30, 2003

(51) Int. Cl. B41J 2/165

(52) U.S. Cl. 347/28

(57) ABSTRACT

A device for applying solvent to an inkjet printhead, the device being arranged to be mounted in an inkjet printer and comprising an applicator adapted to hold solvent and a positioning mechanism arranged to bring the applicator into contact with a substantial portion of the nozzle area of the printhead at substantially the same time.

### FIELD OF THE INVENTION

The present invention relates to a system and method for servicing an inkjet cartridge or pen and, more particularly to a system and method for applying solvent to the nozzle area of an inkjet cartridge or pen.

### BACKGROUND OF THE INVENTION

Inkjet printing mechanisms may be used in a variety of different products, such as plotters, facsimile machines and inkjet printers, to print images using a colorant, referred to generally herein as “ink”. These inkjet printing mechanisms use inkjet cartridges, often called “pens”, to shoot drops of ink onto a page or sheet of print media.

Each pen has a printhead formed with very small nozzles through which the ink drops are fired. The particular ink ejection mechanism within the printhead may take on a variety of different forms. For example, piezo-electric or thermal printheads are well understood by those skilled in the art. In a thermal system, a barrier layer containing ink channels and vaporization chambers is located between a nozzle orifice plate and a substrate layer. This substrate layer typically contains linear arrays of heater elements, such as resistors, which are energized to heat ink within the vaporization chambers. Upon heating, an ink droplet is ejected from a nozzle associated with the energized resistor.

To print an image, the printhead may be scanned back and forth across a printzone above a sheet, with the pen shooting drops of ink as it moves. By selectively energizing the resistors as the printhead moves across the sheet, ink is expelled in a pattern on the print media to form a desired image (e.g. a picture, chart or text).

To clean and protect the printhead, typically a “service station” system is mounted within the printer. In this way, the printhead may be periodically moved over to the service station for maintenance. Such service stations may include a capping system arranged to hermetically seal printhead nozzles from contaminants and drying during periods of non-use. They may also include one or more “spittoons” which are reservoirs arranged to store waste ink ejected from printhead nozzles during “spitting” routines. Spitting routines may be implemented from time to time to clear blockages in the printhead nozzles caused by dried ink, for example.

Service stations are frequently arranged to wipe the printhead with a solvent compound from time to time. In this way, the face of the printhead may be cleaned by dissolving dried ink residue, and the removal of other debris, such as well paper dust.

Solvents, such as a polyethylene glycol (“PEG”), are used, which dissolve accumulated ink residue on the printheads and retard the further collection of such residue. Over recent years, new quick drying inks, both pigment and dye based, have been developed. Such quick drying inks allow inkjet printing mechanisms to form high quality images on readily available and economical plain paper, as well more specialist media. Furthermore, modern printheads use very small ink ejection nozzles that are suitably sized for high-resolution printing. The combination of small nozzles with quick-drying ink makes modern printhead susceptible to failure in the event that some or all of the nozzles become clogged with dried ink or minute dust particles, such as paper fibres. Thus, the role of ink solvents in maintaining the health of the printhead nozzles has grown in importance.

At the same time, increasingly large printheads have been developed, in order to increase the speed at which inkjet devices may print. This has made it increasingly difficult to apply solvent uniformly across the whole of the nozzle area of a modern printhead using conventional techniques. As a consequence a proportion of the nozzles in a large printhead may not be adequately serviced.

It would therefore be desirable to provide an apparatus and method, which addresses this issue.

### SUMMARY OF THE INVENTION

According to one aspect of the invention, there is provided a device for applying solvent to an inkjet printhead, the device being arranged to be mounted in an inkjet printer and comprising an applicator adapted to hold solvent and a positioning mechanism arranged to bring the applicator into contact with a substantial portion of the nozzle area of the printhead at substantially the same time.

Advantageously, by arranging for a solvent laden applicator to contact a substantial portion of the nozzle area of the printhead at substantially the same time, sufficient solvent may be applied in a substantially uniform manner over that portion of the nozzle area to adequately service the nozzles present in that area.

Preferably, the applicator includes a solvent absorbent material which is suitable for depositing solvent on the nozzle area of the printhead when it is pressed against the printhead with a predetermined force. In a preferred embodiment, the dimensions of the applicator are chosen to match the dimensions of the printhead which it is to service. In this manner, the entire nozzle area of the printhead may preferably be wetted with solvent in a uniform manner by bringing the applicator into contact with the printhead in a single application. Thus, embodiments of the present invention may be described as being scalable, since in these embodiments, the applicator may be suitably dimensioned to service efficiently the nozzle plate of a pen of any reasonable size. This is in contrast to certain prior art methods where a wiper, loaded with solvent, is moved progressively across a printhead. Using such prior art methods, the maximum size of printhead which may be adequately serviced tends to be limited by the quantity of solvent that the wiper may be loaded with.

In one preferred embodiment of the invention, the applicator is arranged to move substantially perpendicularly towards the surface of the nozzle plate of the pen, which it is to service. In this embodiment, the applicator may move from a resting position in which the applicator is not in contact with the nozzle plate of the pen to a servicing position in which the applicator is in contact with the nozzle plate of the pen. Advantageously, this embodiment of the invention allows the applicator to be incorporated into a printer in a space efficient manner. For example, a servicing device, incorporating an applicator, may have a footprint that is approximately the same, or indeed even less than that of an inkjet pen which it is arranged to service. This gives rise to certain advantages. For instance, in the case of a scanning printer that has many pens, a wide (in the scanning direction) printer carriage is required to house the pens. This may undesirably increase the mass and expense of the carriage. Additionally, this in turn may increase the distance that the scanning axis must extend on either side of the printzone in order to allow the print carriage to reverse direction between scans. This is often known as the “overtravel” distance. Thus, the relatively small dimensions of servicing devices according to certain embodiments of the invention means that the width of the print carriage in the scanning direction may also be relatively small. For the same reason, the overall footprint of the printer may also be relatively small.

Preferably, the applicator is movable by a positioning system such that it is free to move between a resting position and a servicing position. In one embodiment this is achieved by mounting the applicator on a movable sled which is supported in a housing. In a preferred embodiment, the sled incorporates a number of cam followers which are arranged to move in cams, or grooves in opposing walls of a housing. During operation, the housing may be translated relative to a printhead. The relative movement between the printhead and the sled may cause the sled to move from the resting position to the servicing position. In other embodiments, other positioning system are employed.

Preferably, the applicator may be recharged with solvent from time to time. In one preferred embodiment, a solvent reservoir is located in the housing and the applicator is recharged with solvent from the solvent reservoir whilst it is in the resting position. Preferably this is achieved using capillary action when the applicator is brought into contact with the solvent in the solvent reservoir. In the preferred embodiment, the solvent is a hygroscopic material such as polyethylene glycol (“PEG”).

Preferably, the applicator and/or the housing is replaceable, so that it/they may be replaced with new units at the end of their working lives by an operator. It is also preferable in certain embodiments that the solvent application devices of embodiments of the present invention be used with other printhead servicing components, such as capping systems, wiping elements, and spittoons. Thus, for example, after applying solvent to a printhead according to an embodiment of the present invention, a wiper may be made to travel across the printhead to wipe away any debris present on the printhead.

The present invention extends to the corresponding servicing method. In another aspects, the present invention extends the corresponding printer device and method of operating a printer.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a perspective view of a large format inkjet printer according to an embodiment of the invention;

FIG. 2 is an enlarged perspective view of the service station of the printer shown in FIG. 1;

FIG. 3a shows a perspective view of a solvent dispensing cartridge according to an embodiment of the invention;

FIGS. 3b and 3c illustrate cross sectional views of the solvent dispensing cartridge illustrated in FIG. 3a; and,

FIGS. 4a-c are a series of schematic representations of solvent dispensing cartridge of FIG. 3 illustrating the process of applying solvent to an inkjet pen of the printer shown in FIG. 1.

### DETAILED DESCRIPTION OF THE BEST MODE FOR CARRYING OUT THE INVENTION

There will now be described examples of the best mode contemplated by the inventors for carrying out the invention.

First Embodiment

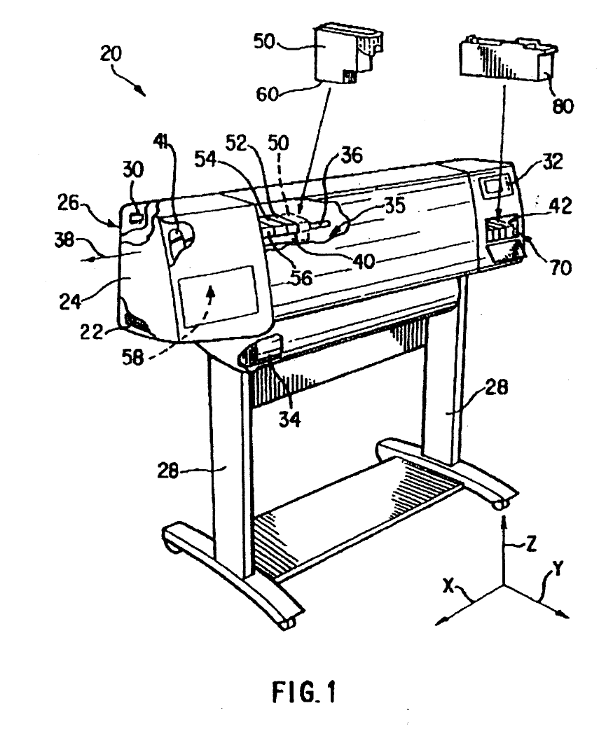

FIG. 1 illustrates a large format inkjet printer 20 according to the first embodiment of the present invention. The printer 20 includes a chassis 22 surrounded by a housing or casing enclosure 24, typically of a plastic material, together forming a print assembly portion 26 of the printer 20. The print assembly portion 26 is supported by a pair of legs 28. The printer 20 also has a print controller, illustrated schematically as a microprocessor 30, that receives instructions from a host device, typically a computer, such as a personal computer or a computer aided drafting (CAD) computer system (not shown). The print controller 30 may also operate in response to user inputs provided through a key pad and status display portion 32, located on the exterior of the casing 24.

A carriage guide rod 36 is mounted to the chassis 22 to define a scanning axis 38, with the guide rod 36 slideably supporting an inkjet carriage 40 for travel back and forth, reciprocally, across the printzone 35. As can be seen from the figure, the scanning axis 38 is aligned with the X-axis. As is shown in the figure, the carriage 40 supports four inkjet cartridges 50, 52, 54 and 56, also known as “pens”. An enlarged view of the pen 50 is illustrated in the figure.

A carriage drive motor 41 may be used to propel the carriage 40 in response to control signals received from the controller 30 in a conventional manner. The carriage guide rod 36 also extends beyond the printzone 35 into a servicing region 42. In this manner, the carriage 40 may be driven to the servicing region, in response to control signals received from the controller 30, so that the pens 50-56 may be serviced. As can be seen from the figure, the servicing region 42 is accessible through an access door 70. In the present embodiment, four pen-servicing devices, or solvent dispensing cartridges, are located in the servicing region. An enlarged view of one of the pen-servicing devices 80 is schematically illustrated in the figure.

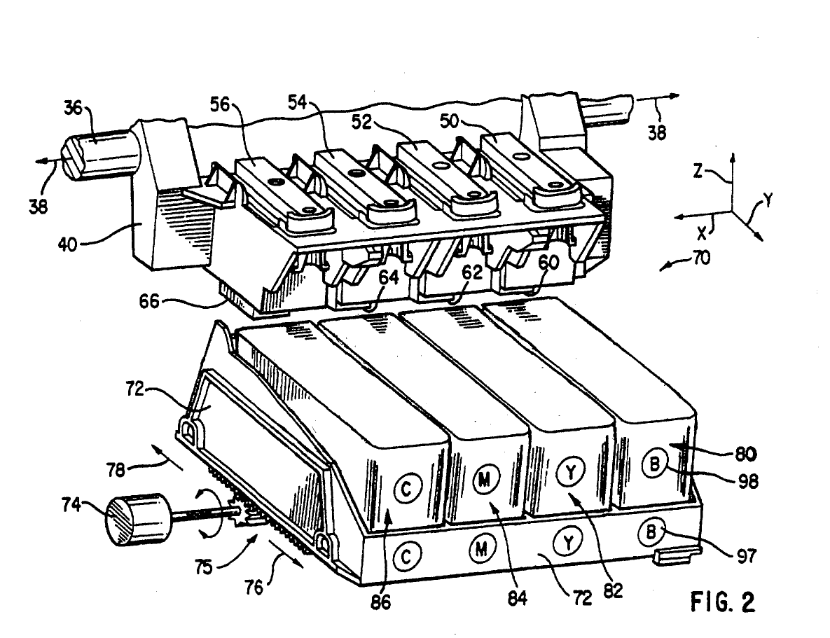

Each pen 50, 52, 54 and 56 has a printhead 60, 62, 64 and 66, which are best illustrated in FIG. 2. The printheads 60-66 may be conventional printheads such as thermal or piezoelectric type and each have a plurality of ink ejection nozzles formed therethrough in a manner well known to those skilled in the art. In the present embodiment, the pens 50-56 respectively print using black, cyan, magenta and yellow inks. This ink may be conventional; for example pigmented or dye based. In the present embodiment, the printheads 60-66 have a large nozzle plate with a large nozzle array. By this, it is meant that they are each arranged to print a large print swath; for instance from approximately 25 millimetres to 75 millimetres (about one inch to three inches) in width. However, the present invention may also be used in conjunction with larger or smaller printheads and nozzle arrays.

The illustrated printer 20 uses a conventional “off-axis” ink delivery system, having main stationary reservoirs (not shown) for each ink colour located in an ink supply region 58. The pens 50-56 may be replenished with ink conveyed through a conventional flexible tubing system (not shown) from the stationary main reservoirs, so only a small ink supply is propelled by carriage 40 across the printzone 35. However, the present invention may also be used in conjunction with “pens” or “cartridges” each of which has a reservoir that carries the entire ink supply as the printhead reciprocates over the printzone.

A conventional print media handling system (not shown) may be used to advance a sheet of print media 34, either from a roll, as is illustrated, or in the form of pre-cut sheets, through a printzone 35. In this way, the media sheet may be correctly positioned to receive the swaths printed by the pens.

FIG. 2 illustrates the carriage 40, supported by the carriage guide rod 36, located in a servicing position in the servicing region 42 of the printer 20. In this position each of the pens 50-56 is suitably positioned to be serviced by a corresponding pen-servicing device.

In the present embodiment, four pen-servicing devices 80, 82, 84 and 86 are employed, as are schematically illustrated in FIG. 2. The pen-servicing devices 80, 82, 84 and 86 are respectively arranged to service the pens 50, 52, 54 and 56. Each of the pen-servicing devices, which may be separately replaceable, is securely located in a respective chamber or stall defined in a service station pallet 72. The pallet 72 is arranged to be translationally moveable, when driven by a motor 74. The motor is arranged to drive the pallet 72 through a rack and pinion gear assembly 75 in a forward direction 76 and in a rearward direction 78 in response to drive signals received from the controller 30. As can be seen from the figure, the directions 76 and 78 are aligned with the Y-axis; i.e. perpendicular to the scanning axis 38.

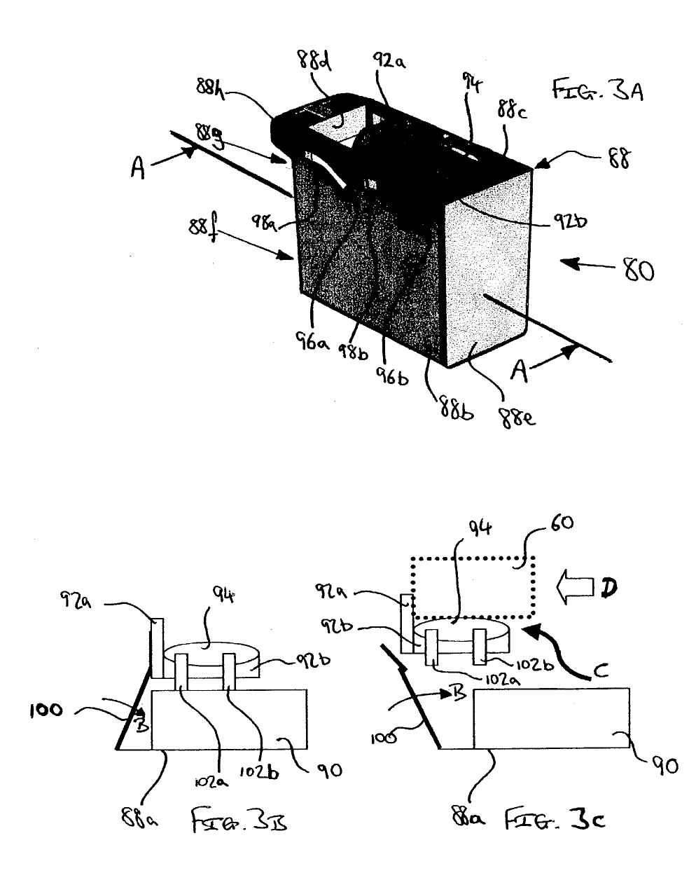

In the present embodiment, each of the four pen-servicing devices 80, 82, 84 and 86 are substantially identical. Referring now to FIGS. 3a, 3b and 3c, one of the pen-servicing devices 80, will now be described in more detail.

FIG. 3a shows a perspective view of pen-servicing device 80, removed from the printer 20. The pen-servicing device 80 has a housing 88 which may be made out of any suitable material; for example an injection moulded plastic material. In the present embodiment, the housing 88 has a base portion 88a (shown in FIGS. 3b and 3c), two side walls 88b and 88c and two end walls 88d and 88e. The lower portion of the housing forms an ink solvent chamber 88f. The solvent chamber is adapted to support a reservoir body or block 90. The reservoir block 90 is illustrated in FIGS. 3b and 3c, each of which illustrates a schematic cross sectional view of pen-servicing device 80a, viewed along lines A-A.

The inkjet ink solvent is preferably a hygroscopic material that absorbs water out of the air, because water is a good solvent for the illustrated inks. Suitable hygroscopic solvent materials include polyethylene glycol (“PEG”), lipponicethylene glycol (“LEG”), diethylene glycol (“DEG”), glycerine or other materials known to those skilled in the art as having similar properties. These hygroscopic materials are liquid or gelatinous compounds that will not readily dry out during extended periods of time because they have an almost zero vapour pressure. For the purposes of illustration, the reservoir block 86 is soaked with the currently preferred ink solvent, PEG.

Preferably, the reservoir block 90 is made of a porous material, with an affinity for the ink solvent which it is to store. In the present embodiment, the reservoir block material is selected to have a capillary pressure that lies in a desired range. It is preferable that its capillary pressure should be sufficiently high to prevent the PEG solvent from leaking out of the reservoir block 90 during transport, or if the pen-servicing device 80 is tilted or inverted. However, its capillary pressure should be sufficiently low to allow free release of the fluid for its intended purpose (i.e. to be applied to the nozzle plate of a given printhead) as is described below. In the present embodiment, the material of the reservoir block 90 is a pultruded, bonded nylon fibre material such as Nylon 6, however, other functionally similar materials known to those skilled in the art may instead be used.

The upper portion 88g of the housing 88 forms a handle portion 88h arranged to allow an operator to handle the pen-servicing device 80, when installing or removing it from the printer 20. The upper portion 88g of the housing 88 also provides a mounting structure for a sled 92.

The sled 92 has a wall portion 92a and a base portion 92b. The base portion 92b is adapted to support a sponge 94. The sponge may be secured in place using conventional techniques such as mechanical fasteners or adhesive. The sled also has four cam followers 96a-d. The cam followers 96a-d are located in four corresponding sled ramps or cams 98a-d, respectively, which are located in the upper portion 88g of the housing. Two of the cams 98a and 98b are formed in the side wall 88b and two of the cams 98c and 98d (not shown) are formed in the side wall 88c of the housing. As can be seen from the figure, the cams 98a and 98b have a generally “S” shaped profile. The profile is arranged such that the cams are positioned higher in the side wall 88b (i.e. further from the base portion 88a of the housing) as they approach the end wall 88d of the housing. The other two cams 98b and 98c have the same profile as the cams 98b and 98c and are located in the other side wall 88d. In the present embodiment, the cams 98b, 98c and the cams 98c, 98d are located symmetrically on either side of axis A-A.

In this manner, the sled is supported between the side walls 88b and 88c of the housing. However, it is free to be displaced parallel to the side walls 88b and 88c to the extent that this is permitted by the cams 98. As the sled is displaced towards end wall 88d of the housing, the sled rises relative to the base 88a of the housing. Conversely, when the sled is displaced towards end wall 88e of the housing, the sled falls relative to the level of the top of the housing. In the present embodiment, the arrangement of cams and cam followers is arranged such that the base portion 92b of the sled and the sponge 94 are maintained approximately parallel to the base portion 88a of the housing as the sled is displaced relative to the cams. In this manner, the upper surface of the sponge is maintained, in use, approximately parallel to the printhead of its corresponding pen.

FIG. 3b, schematically illustrates the position of the sled when it is displaced to its maximum permissible extent towards end wall 88e of the housing. As is shown in FIGS. 3b and 3c, a spring 100 (in this example a laminar spring) is used to bias the sled to its lowest position relative to the top of the housing; i.e. towards the end wall 88e of the housing. As is illustrated in the figures, the biasing force of the spring 100 is in the direction of the arrow “B”.

As has been described above, the sled comprises an actuation wall 92 that projects perpendicularly from the base portion of the sled. In the present embodiment, the actuation wall portion 92a extends upwardly relative to base portion of the sled such that it extends above the upper surface of the housing 88, irrespective of the position of the sled cam followers 92 in the cams 94. As force is applied to the actuation wall portion 92a, in the direction of the end wall 88d of the housing (as illustrated by the arrow “D” in FIG. 3c), the biasing force of the spring 100 may be overcome. In this manner, the sled may move relative to the housing along the cams 98 (as illustrated by the curved arrow “C” in FIG. 3c) in the direction of the end wall 88d. In the present embodiment, this force may be applied by a face of the printhead being serviced by the pen-servicing device 80. This is explained more fully below. In this example this is printhead 60, as is shown in FIG. 3c. FIG. 3c, schematically illustrates the position of the sled when it is displaced to its maximum permissible extent towards end wall 88d of the housing.

Also illustrated in FIGS. 3b and 3c are a pair of fibre conductors 102a and 102b. The fibre conductors 102a and 102b are fixed relative to the sled so that one end of each of the fibre conductors 102a and 102b is embedded in the sponge 94. The other end of each of the fibre conductors is arranged to contact the reservoir block 90 when the sled is located near the end wall 88e of the housing; i.e. low in the housing 88, as is illustrated in FIG. 3b. However, as can be seen from FIG. 3c, the fibre conductors 102a and 102b cease to contact the reservoir block 90 as the sled is raised sufficiently relative to the reservoir block 90; as is shown in FIG. 3c, for example.

The fibre conductors 96 are arranged to transport the solvent held in the reservoir block 90 to the sponge 94. In the present embodiment, the fibre conductors and the sponge are in fact made from the same material and indeed may be manufactured as a single unit. In the present embodiment, the material chosen for the fibre conductors 102 and the sponge 94 is selected to be self-wetting or hydrophilic, allowing the material to fill with fluid, by capillary action, of its own volition once in contact with the reservoir block 90. Thus, it is selected to have a sufficiently high capillary pressure to overcome the capillary pressure of the reservoir block 90 and to provide for a vertical rise or fluid head to the level of the sponge 94. Thus, it has an even greater affinity for the solvent used than does the material of the reservoir block 94. In the present embodiment, material used for the sponge and fibre conductors is porous, sintered High Density Polyethylene. It will of course be appreciated that the sponge and fibre conductors may be made from different functionally similar materials.

As has been stated above, each of the pen-servicing devices may be removed by a user from the pallet 72 when it requires replacement; for example when its supply of PEG runs out, or the unit becomes otherwise unserviceable. It will be appreciated that in order to prevent cross contamination of different color ink supplies on the nozzle plates of the four pens, it is preferable not to install a pen-servicing device which has been used to service a pen of one color in the stall of the service station pallet 72 associated with the pen of another colour. This aim may be achieved by equipping the pen-servicing devices with mechanical lockouts that allow the installation of each pen-servicing device in only one of the stalls. Alternatively, or additionally, the stalls and the pen-servicing devices may be marked to indicate the correct stall for a given pen-servicing device. For example, in FIG. 2, the pen-servicing device arranged to service the black pen is marked with a letter “B” and its corresponding stall is similarly marked with a letter “B”. These marks are referenced 97 and 99, respectively.

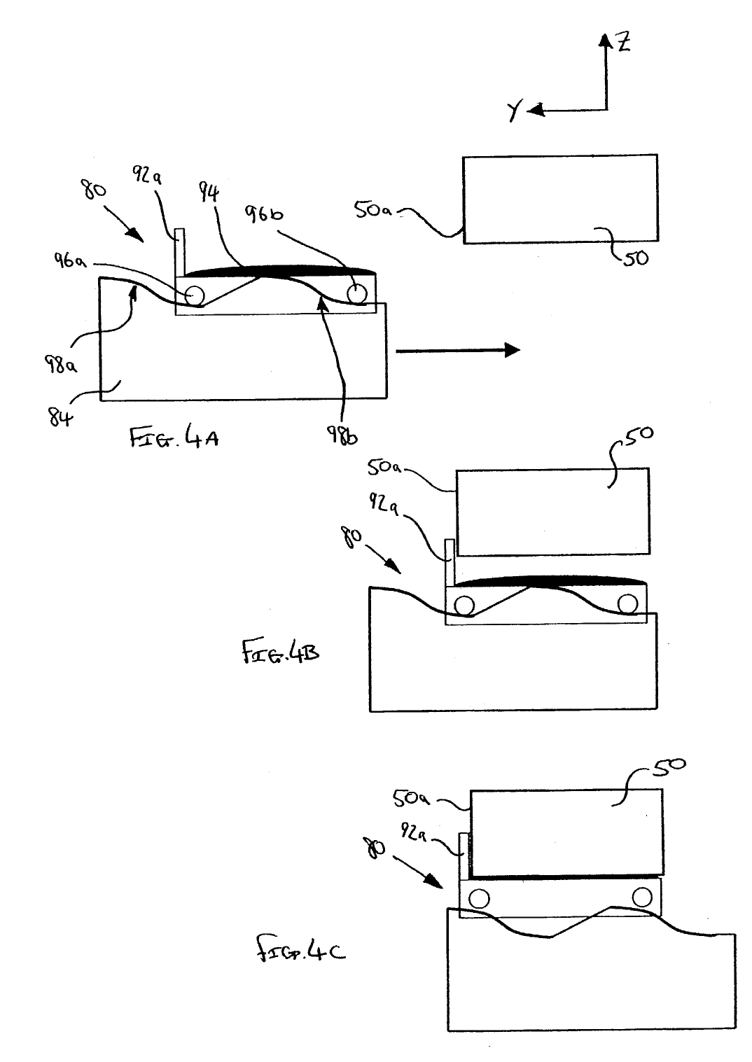

When the controller 30 determines that PEG should be applied to the nozzle area of one or more of the pens, the carriage 40 is moved to the servicing position in the servicing region 42 as is illustrated in FIG. 2. The process of applying PEG to the nozzle area of one or more of the pens according of the present embodiment is illustrated in the sequence of FIGS. 4a-c. For the purposes of clarity, only one pen and one pen-servicing device are illustrated in the figures; in this case the black pen 50 and its corresponding pen-servicing device 80. However, the skilled reader will appreciate that in practice, according to the present embodiment, PEG solvent may be applied simultaneously to each of the pens 50-56 by their corresponding pen-servicing devices 80-86.

FIG. 4a illustrates the relative positions of the pen 50 and the pen-servicing device 80, prior to commencement of the process of applying PEG to the nozzle area of the pen. Thus, their relative positions in FIG. 4a correspond to those illustrated in FIG. 2. As can be seen from FIG. 4a, the pen 50 and the pen-servicing device 80 are spaced apart in the Y direction. The pen is located stationary, by virtue of its mounting within the carriage 40. The pen-servicing device 80 is mounted in its stall in the service station pallet 72. In this state, the sled 92 is biased by the spring 100 towards its lowest position relative to the top of the housing; i.e. towards the end wall 88e of the housing. For the sake of clarity, various structures are not shown in FIG. 4. Amongst others, these include; the carriage 40; the service station pallet 72; the spring 100; and, the upper portion 88g of the pen-servicing device 80.

The service station pallet 72 is then driven in the direction of the arrow shown in FIG. 4a by the motor 74. This corresponds to the direction 78 shown in FIG. 2. As the motion of the service station pallet 72 continues, the actuation wall 92a of the sled contacts the forward facing surface 50a of pen 50. This is illustrated in FIG. 4b. The service station pallet 72 continues to travel in the direction of the arrow shown in FIG. 4a. Thus, the housing 88 of the pen-servicing device 80 proceeds to pass further underneath the pen 50. However, the sled 92 is prevented from moving further in this direction through the contact between the actuation wall 92a of the sled and the forward facing surface 50a of pen. Thus, the cam followers 96 of the sled move along cams 98 formed in the side walls 88b and 88c, as the housing 88 moves relative to the sled 92. Due to the “S” shaped profile of the cams, this has the effect of elevating the sled 92 relative to the pen 50 and relative to the housing of the pen-servicing device.

When the sled 92 reaches its highest position relative to the housing 88, the movement of the service station pallet 72 stops. In this position, the sponge 94 has been brought into a press contact with the nozzle plate 60 of the pen 50, as is shown in FIG. 4c. This has the effect of expelling PEG solution from the compressed sponge 94 onto the surface of the nozzle plate 60. As can be seen from the illustration, in the present embodiment the sponge 94 is sized and located on the sled such that when the pen-servicing device is in the state shown in FIG. 4c, a desired quantity of PEG is applied substantially uniformly over the entire nozzle area of the nozzle plate 60. In this manner, all nozzles which may be blocked with dried ink, air bubbles, or paper fibres etc. may be serviced.

The service station pallet 72 is subsequently driven in the reverse direction by the motor 74. This corresponds to the direction 76 shown in FIG. 2, moving the pen-servicing device 80 back to the position illustrated in FIG. 4a. As the motion of the service station pallet 72 progresses, the sled moves towards the end wall 88e of the housing of the pen-servicing device 80, under the biasing force of the spring 100. However, a uniform application of PEG is left on the printhead surface. In this manner, the sled returns to its position located near the end wall 88e of the housing; i.e. low in the housing, as is illustrated in FIG. 3b. In this position, the fibre conductors once again make contact with the reservoir block 90 and allow the sponge 94 to absorb more solvent in readiness for the next PEG applying operation.

It will be understood that in the present embodiment, whilst the sled 92 is being raised or lowered in the Z axis, it is substantially stationary in the X and the Y axes with respect to the nozzle plate 60. Thus, in the present embodiment, the sponge applies PEG to the nozzle plate 60 substantially without wiping the nozzle plate; i.e. there is substantially no relative movement between the sponge and the nozzle plate in the X or Y directions. It will be understood, however, that in other embodiments, such a wiping action may be introduced.

It will be also be understood that the structure and operation of pen-servicing devices 80-86 of the present invention allow them to be located in a side-by-side manner, as illustrated in FIG. 2, in a very space efficient manner. This gives rise to several advantages. Firstly, the service station does not increase the length of the scan axis unduly, which helps reduce the overall footprint of the printer. Secondly, the pen-to-pen spacing need not be increased to allow for the operation of pen-servicing devices 80-86; i.e. the pen-servicing devices may have a dimension in the scan axis direction which does not exceed that of the pens, whilst being arranged to apply PEG to the entire nozzle plate area of the corresponding pens. As has been described above, this also avoids having to increase the length of the scan axis of the printer.

Following the process of applying PEG to one or more pens, the carriage 40 may exit the servicing region 42 and enter the printzone 35 to start or continue a printing operation.

From the foregoing it will be understood that the present embodiment provides a method for applying a solvent at the same time, substantially uniformly over the entire nozzle area of a printhead. Furthermore, this is achieved using a relatively simple mechanism, requiring the use of only one axis of motion to apply the PEG; i.e. moving the pen-servicing devices 80-86 rearwardly and then forwardly again, as indicated by arrows 78 and 76 in FIG. 2. Consequently, only one drive motor is required, providing a comparatively reliable and inexpensive solution.

Furthermore, the design of the mechanism used in the present embodiment for applying the PEG is scalable. Thus, pen-servicing devices according to embodiments of the present invention may be resized to allow PEG to be uniformly applied to the nozzle plate of a pen of any reasonable size.

Further Embodiments

In the above embodiment numerous specific details are set forth in order to provide a thorough understanding of the present invention. It will be apparent to one skilled in the art, however, that the present invention may be practiced without limitation to these specific details. In other instances, well known methods and structures have not been described in detail so as not to unnecessarily obscure the present invention.

In other embodiments of the invention further servicing components may be employed; for example, a capping system, one or more spittoons, or one or more wiper elements. These further servicing components may be of conventional design and so they will not be described further here. Such further servicing components may be incorporated in the same service station as the pen-servicing devices. Alternatively, they may be located in a further service station. The further service station may be located, for example, at a separate location along the scan axis to the same service station of the pen-servicing devices 80-86. In either case, the further servicing components may be arranged to be operated either dependently or independently of the operation of the pen-servicing devices.

Although in the above-described embodiment, the pen-servicing devices are described as being replaceable, the skilled reader will appreciate that this need not be the case. For example, further solvent may be added to the solvent reservoir by any suitable means, as required. This may be via a supply tube connected to a solvent container located within the printer for example.

Furthermore, although the above-described embodiment was described in the context of a reciprocating inkjet printer, it will be apparent that in further embodiments non-reciprocating printheads may be serviced, in the manner described in the above-embodiment. For example, statically mounted page-wide arrays of printheads.

Although in the above embodiment, the sled is arranged to move relative to the pen-servicing device housing on a camming system, it will be understood that other mechanisms may instead be used in other embodiments of the invention. For example, the sled may be arranged to be pivotally mounted to the pen-servicing device housing. In this manner, it may be arranged to rotate between a position in which the applicator sponge is in contact with the printhead and a position in which the applicator sponge is not in contact with the printhead. A dedicated, conventional drive motor may be used to cause this rotation. As a further alternative the applicator sponge may be mounted on the end of a linear piston, or spring. Activation of the piston may be used move the applicator sponge into and out of contact with the printhead.

Additionally, although the above embodiment was described with reference to a large format printer, it will be understood that the present invention may also be applied to other inkjet printing mechanisms, such as: desk top printers, portable printing units, copiers and facsimile machines, to name a few.

Additionally, although in the above embodiment each sponge is designed to apply solvent over substantially the entire nozzle area of a given printhead, the skilled reader will appreciate that in other embodiments of the invention, this need not be the case. For example, a sponge may be arranged to apply solvent over substantial fraction of the nozzle area of a given printhead, for example one half or a third or the nozzle area. The remaining area may have solvent applied to it in one or more further solvent application processes. The one or more further solvent application processes may be carried out by the same or further sponge or pen-servicing devices.

What is claimed is:

1. A device for applying solvent to an inkjet printhead, the device being arranged to be mounted in an inkjet printer and comprising an applicator adapted to hold solvent and a positioning mechanism arranged to bring the applicator into contact with a substantial portion of the nozzle area of the printhead at substantially the same time.

2. A device according to claim 1, further comprising a solvent reservoir arranged to recharge the applicator with solvent.

3. A device according to claim 2, wherein the applicator is movable to a recharging reposition in which it is in fluid communication with solvent in the solvent reservoir.

4. A device according to claim 3, wherein solvent is arranged to move from the solvent reservoir to the applicator by capillary action when the applicator is in the recharging position.

5. A device according to claim 4, wherein the solvent reservoir comprises a solvent absorbent material.

6. A device according to claim 5, wherein the applicator comprises a solvent absorbent material with an affinity for the solvent greater than that of the solvent reservoir.

7. A device according to claim 6, wherein the applicator material is sintered high density polyethylene, or similar material and the reservoir material is Nylon 6, or similar material.

8. A device according to claim 2, wherein the solvent is a hygroscopic material such as polyethylene glycol (“PEG”), lipponic-ethylene glycol (“LEG”), diethylene glycol (“DEG”), glycerine or other suitable material.

9. A device according to claim 1, further comprising a support structure adapted to support the applicator, the positioning mechanism being arranged to permit the applicator to move relative to the support structure between first and second positions in which it is respectively arranged to contact and not to contact the printhead.

10. A device according to claim 9, further arranged to recharge the applicator with solvent when the applicator is in the second position.

11. A device according to claim 10, wherein the support structure houses a solvent reservoir, the applicator being arranged when in the second position to be in fluid communication with solvent in the solvent reservoir.

12. A device according to claim 9, wherein the applicator is biased towards the second position using a spring or similar biasing means.

13. A device according to claim 9, further comprising an actuation surface adapted to receive an actuation force, the applicator being arranged to move from the second to the first position in response to the actuation force.

14. A device according to claim 13, wherein the positioning system comprises a cam/cam follower arrangement, arranged to allow the applicator to translate from the second to the first position in response to the actuation force.

15. A device according to claim 13, wherein the applicator is pivotally mounted on the support structure, the applicator being arranged to rotate from the second to the first position in response to the actuation force.

16. A device according to claim 1, wherein the device is a replaceable part of an inkjet printer.

17. A device for applying solvent to an inkjet printhead, the device being arranged to be mounted in an inkjet printer and comprising: an applicator arranged to hold solvent, the applicator being adapted to be brought into contact with the printhead so as to apply solvent substantially the same time to substantially the entire nozzle area of the printhead.

18. An inkjet printer comprising a printhead and a system for applying a solvent to the nozzle area of the printhead, the system comprising a pallet arranged to translate relative to the printhead in a first direction and in so doing to engage a camming system adapted to translate a solvent applicator in a second direction so as to cause the applicator to contact substantially simultaneously substantially the entire nozzle area of the printhead.

19. A printer according to claim 18, wherein the applicator is arranged to be substantially stationary in the first direction whilst being translated in the second direction.

20. A method of operating a service station in an inkjet printer comprising the step of moving an applicator adapted to hold solvent into contact with the printhead so as to apply solvent substantially simultaneously to substantially the entire nozzle area of the printhead.

21. The method of claim 20, comprising the further step of: moving the applicator away from the nozzle area of the printhead such that the applicator is brought into a position in which it may be recharged with solvent.
